(19) United States
(12) Patent Application Publication
(10) Pub. No.: US 2015/0017899 A1
(43) Pub. Date: Jan. 15, 2015

(54) SYSTEM FOR MIXING CABIN AIR AND OUTSIDE AIR OF AIR-CONDITIONER FOR VEHICLE AND METHOD OF CONTROLLING THE SAME

(71) Applicants: Kia Motors Corp., Seoul (KR); Halla Visteon Climate Control Corp., Daejeon (KR)

(72) Inventors: Yong Chul KIM, Hwaseong-si (KR); Sung Hae PARK, Busan (KR); Byeong Moo JANG, Suwon-si (KR); Jung Jae LEE, Daejeon (KR); Tae Eun KIM, Daejeon (KR)

(73) Assignees: Kia Motors Corp., Seoul (KR); Halla Visteon Climate Control Corp., Daejeon (KR)

(21) Appl. No.: 14/285,249

(22) Filed: May 22, 2014

(30) Foreign Application Priority Data
Jul. 11, 2013 (KR) 10-2013-0081630

(51) Int. Cl. B60H 1/00; B60H 1/24

(52) U.S. Cl. CPC B60H 1/00785; B60H 1/24
USPC 454/75; 454/152

(57) ABSTRACT

A system and a method for mixing cabin and outside air of a vehicle air-conditioner may include a housing having cabin and outside air inlets for ventilating the cabin and outside air, a first door part to selectively cover at least a portion of the cabin air inlet and/or a portion of the outside air inlet to adjust an open value of each of the inlets, a second door part to selectively cover the remaining portion of the outside air inlet to adjust the open value of the outside air inlet, a cam part rotatable in the housing and formed with first and second slots to which the first and second door parts are slidably coupled such that rotation angle of the first or the second door part is varied according to rotation of the cam part, and a controlling unit controlling the rotation of the cam part.

### CROSS REFERENCE TO RELATED APPLICATION

room The present application claims priority of Korean Patent Application Number 10-2013-0081630 filed on Jul. 11, 2013, the entire contents of which application are incorporated herein for all purposes by this reference.

### BACKGROUND OF INVENTION

1. Field of Invention

The present invention relates to a system for mixing cabin air and outside air of an air-conditioner for a vehicle capable of providing pleasant air to an interior of the vehicle taking account of carbon dioxide and humidity in the vehicle, and a method of controlling the same.

2. Description of Related Art

In general, a vehicle is installed with an air-conditioner and is provided with a heating and cooling system so as to provide cold air or hot air to an interior of the vehicle. The air-conditioner mentioned above may selectively control whether to perform an outside air mode in which air discharged into the interior introduces outside air or to perform a cabin air mode circulating cabin air.

To this end, the air-conditioner is installed with a cabin air and outside air door capable of selectively opening or closing a cabin air inlet and an outside air inlet.

In an air-conditioner according to the related art, the cabin air inlet and the outside air inlet are formed so as to be selectively closed according to a rotation of the cabin air and outside air door.

The air-conditioner according to the related art has mixed a predetermined amount of outside air due to a concern about an increase in an amount of carbon dioxide in the interior. However, because it mixes the outside air even under a condition having a small amount of carbon dioxide, ventilation loss was caused.

Meanwhile, when the user selects the cabin air mode to thereby continuously circulate only the cabin air, the amount of carbon dioxide in the vehicle may be increased, resulting in an unpleasant interior environment. In addition, in a case of the cabin air mode, since humidity in the vehicle is increased due to breathing of passengers, visibility defect is caused by the increased humidity, resulting in stability problem.

Further, a demand for an environmentally friendly vehicle is recently increased, where it is important for the environmentally friendly vehicle to secure a distance capable of driving on a single charge. In a case of the environmentally friendly vehicle mentioned above, energy has been significantly consumed by the air-conditioner using power and particularly, has been significantly consumed by the ventilation loss. However, since a technique of controlling the air-conditioner used in existing environmentally friendly vehicles partially introduces the cabin air only in a case of a specific condition such as a low speed of vehicle, a high volume of air, or the like, there is a limitation in preventing the ventilation loss.

In addition, even in the case in which the cabin air and the outside air are simultaneously introduced, as a driving speed of the vehicle is increased, the outside air is not introduced into a blower side and flows backward into the interior of the vehicle due to a pressure difference, such that a passenger sitting in the passenger seat may feel the cold on his/her knee and heating and cooling performance of the interior of the vehicle may be degraded.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention are to provide a system for mixing cabin air and outside air of an air-conditioner for a vehicle capable of decreasing ventilation loss while introducing the outside air according to carbon dioxide and humidity in a vehicle interior, and a method of controlling the same.

According to one aspect of the present invention, there is provided a system for mixing cabin air and outside air of an air-conditioner for a vehicle. The system may include a housing of the air-conditioner having a cabin air inlet for ventilating the cabin air and an outside air inlet for ventilating the outside air, a first door part provided to selectively cover at least a portion of the cabin air inlet and/or a portion of the outside air inlet to thereby adjust an open value of each of the inlets, a second door part provided to selectively cover the remaining portion of the outside air inlet to thereby adjust the open value of the outside air inlet, a cam part rotatably installed in the housing and formed with first and second slots, wherein the first door part is slidably coupled to the first slot and the second door part is slidably coupled to the second slot such that a rotation angle of the first door part or the second door part is varied according to a rotation of the cam part, and a controlling unit controlling the rotation of the cam part.

The first door part may be formed in a substantially dome form having a fan shape, and the second door part may be formed in a substantially flat form having a plate shape.

The first slot of the cam part may be formed to be linearly extended and have both ends which are bent toward a center of the cam part, and the second slot of the cam part may be formed to be bent at a predetermined curvature. The first slot and the second slot of the cam part may be formed to be substantially perpendicular to each other.

The cam part may be rotated by a driving motor provided therein, and the controlling unit may adjust the rotation of the driving motor by transmitting a control signal to the driving motor.

The system may further include a CO₂ sensing unit detecting an amount of carbon dioxide in a vehicle interior and a humidity sensing unit detecting humidity in the vehicle interior, wherein the controlling unit may adjust an introduction amount of the outside air by adjusting the cam part when the amount of the carbon dioxide in the interior transmitted by the CO₂ sensing unit is equal to or greater than a reference value and/or the humidity in the interior transmitted by the humidity sensing unit is equal to or greater than a reference value.

According to another aspect of the present invention, there is provided a method of controlling the system for mixing cabin air and outside air of an air-conditioner for a vehicle as described above. The method may include a mode determination operation of determining a cabin air circulation state or an outside air introduction state, a first determination operation of checking an amount of carbon dioxide in an interior and determining an introduction amount of the outside air based on the amount of the carbon dioxide in a case of the cabin air circulation state, a second determination operation of checking whether or not humidity in the interior is equal to or greater than a reference value and determining an introduction amount of the outside air based on the humidity when the humidity is equal to or greater than the reference value, and an outside air introduction operation of adjusting the open value of the outside air inlet so that the outside air is introduced based on the introduction amounts of the outside air derived from the first determination operation and/or the second determination operation.

In the outside air introduction operation, between the introduction amounts of outside air derived by the first determination operation and the second determination operation, the introduction amount of the outside air according to the humidity in the second determination operation may be firstly controlled, in the case in which both carbon dioxide and humidity in the interior are equal to or greater than the reference value or reference values.

In the outside air introduction operation, the open value of the outside air inlet may be adjusted based on the introduction amount of the outside air derived by the first determination operation or the introduction amount of the outside air derived by the second determination operation, whichever is larger, in the case in which both carbon dioxide and humidity in the interior are equal to or greater than the reference value or reference values.

The mode determination operation may further include an additional determination operation of checking a driving speed of the vehicle in a case of the outside air introduction state and determining the introduction amount of the outside air for the driving speed when the driving speed of the vehicle is equal to or greater than a reference or predetermined speed.

In the outside air introduction operation, the open value of the outside air inlet may be decreased so that the outside air is introduced based on the introduction amount of the outside air calculated by the additional determination operation.

In the outside air introduction operation, the open value of the outside air inlet may be adjusted so that the outside air is introduced based on the introduction amounts of the outside air derived by the additional determination operation, the first determination operation, and/or the second determination operation, the introduction amount of the outside air calculated by the second determination operation may be firstly controlled.

In the additional determination operation, as the driving speed of the vehicle is high, a shift level of a blower may be increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an exemplary system for mixing cabin air and outside air of an air-conditioner for a vehicle according to the present invention;

FIG. 2 is a cross-section view showing the system for mixing cabin air and outside air of the air-conditioner for the vehicle shown in FIG. 1;

FIG. 3 is a view showing an exemplary cam part of the system for mixing cabin air and outside air of the air-conditioner for the vehicle shown in FIG. 1;

FIGS. 4 to 6 are views showing operation states of a first door part, a second door part, and the cam part according to operation states of the system for mixing cabin air and outside air of the air-conditioner for the vehicle shown in FIG. 1 according to the present invention; and

FIG. 7 is a flow chart of an exemplary method of controlling a system for mixing cabin air and outside air of an air-conditioner for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

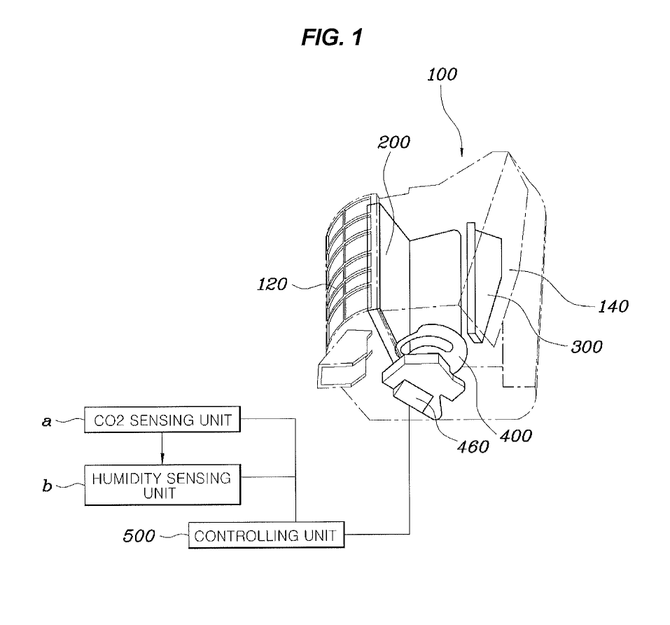

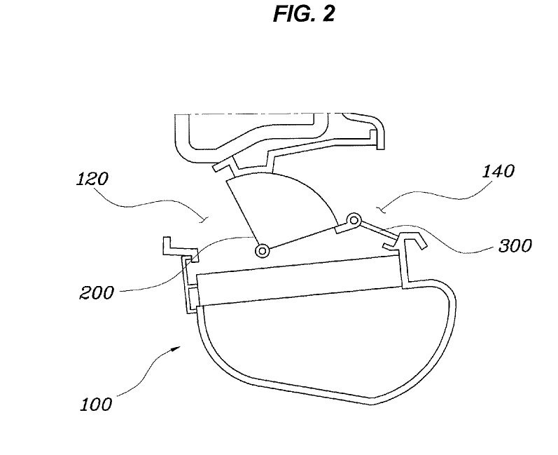

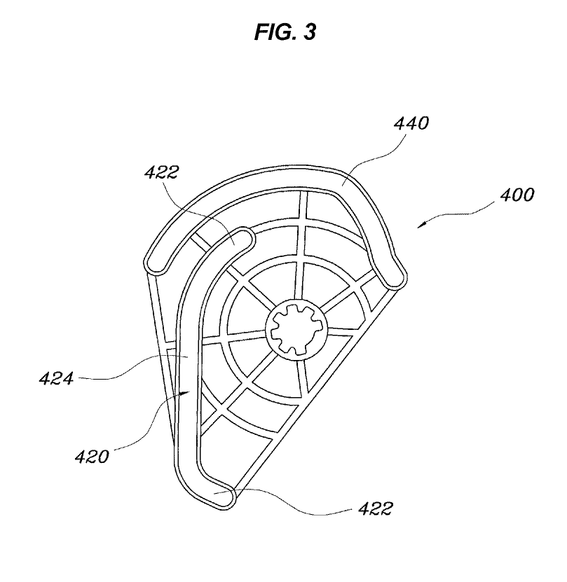

FIG. 1 is a view showing a system for mixing cabin air and outside air of an air-conditioner for a vehicle according to various embodiments of the present invention, FIG. 2 is a cross-section view showing the system for mixing cabin air and outside air of the air-conditioner for the vehicle shown in FIG. 1, and FIG. 3 is a view showing a cam part of the system for mixing cabin air and outside air of the air-conditioner for the vehicle shown in FIG. 1.

A system for mixing cabin air and outside air of an air-conditioner for a vehicle according to various embodiments of the present invention may include a housing 100 of the air-conditioner having a cabin air inlet 120 which is ventilated with cabin air and an outside air inlet 140 which is ventilated with outside air; a first door part 200 provided so as to cover portions of the cabin air inlet 120 or the outside air inlet 140 to thereby adjust an open value of each of the inlets; a second door part 300 provided so as to cover other portions of the outside air inlet 140 to thereby adjust the open value of the outside air inlet 140; a cam part 400 rotatably installed in the housing 100 and varying a rotation angle of the first door part 200 or the second door part 300 according to a rotation thereof by having a first slot 420 to which the first door part 200 is connected to be slid and a second slot 440 to which the second door part 300 is connected to be slid; and a controlling unit 500 controlling the rotation of the cam part 400.

The housing 100 according to the present invention is provided with the first door part 200 and the second door part 300. Here, the first door part 200 is provided to cover portions of the cabin air inlet 120 or the outside air inlet 140 and opens or closes each of the cabin air inlet 120 and the outside air inlet 140 according to a rotation itself, thereby allowing an introduction of cabin air or outside air to be switched.

That is, when the first door part 200 is rotated to the cabin air inlet 120 side, the cabin air inlet 120 is closed, such that only the introduction of outside air through the outside air inlet 140 is allowed. When the first door part 200 is rotated to the outside air inlet 140 side, the outside air inlet 140 is closed, such that only a circulation of cabin air through the cabin air inlet is allowed.

However, according to the present invention, in adjusting the open value of the outside air inlet 140, since the first door part 200 is formed so as to close a portion of the outside air inlet 140 and the second door part 300 is formed so as to close other portions of the outside air inlet 140 remaining after the first door part 200 closes, the open value of the outside air inlet 140 is adjusted by the first door part 200 and the second door part 300.

Here, the first door part 200 may be formed in a dome or substantially dome form having a fan shape and the second door part 300 may be formed in a flat or substantially flat form having a plate shape. In a case of the first door part 200, the first door part 200, which is to close portions of the cabin air inlet 120 and the outside air inlet 140, causes large load due to the introduction of the cabin air and the outside air when being rotated to the cabin air inlet 120 side or the outside air inlet 140 side. Further, the first door part 200 allows the outside air introduced from the outside air inlet 140 side not to flow backward into the cabin air inlet 120 side by completely blocking the introduction of the cabin air when being rotated to the cabin air inlet 120 side.

Therefore, the first door part 200 is configured in the dome form having the fan shape to prevent durability from being decreased by over-load generated at a shaft due to the introduction of the cabin air and the outside air when being rotated to the cabin air inlet 120 side or the outside air inlet 140 side, and may increase sealing effect by increasing an area contacting inner walls of the housing 100 at the time of moving to the cabin air inlet 120 side or the outside air inlet 140 side as being configured in the dome form. Meanwhile, although the second door part 300 is provided to open or close the portion of the outside air inlet 140, it has substantially a narrow width adjusting the open value of the outside air inlet 140 to thereby have a small load amount due to the introduction of the outside air. Of course, the second door part 300 may also be configured so as to have the dome form. However, since the second door part 300 has a small load caused by the introduction of the outside air, it is preferable to decrease costs by configuring the flat form.

The first door part 200 and the second door part 300 mentioned above are connected to the cam part 400 to thereby vary the rotation angles thereof. The cam part 400 mentioned above is rotatably installed in the housing 100 and is provided with the first slot 420 to which the first door part 200 is connected to be slid and the second slot 440 to which the second door part 300 is connected to be slid.

Here, in the cam part 400, as shown in FIG. 3, the first slot 420 of the cam part 400 may be formed to be linearly extended and have both ends which are bent toward a center, the second slot 440 may be formed to be bent at a predetermined curvature, and the first slot 420 and the second slot 440 of the cam part 400 may be formed to be vertical or substantially perpendicular to each other.

In addition, the cam part 400 is rotated by a driving motor 460 provided therein, and the controlling unit 500 may adjust the rotation of the driving motor 460 by transmitting a control signal to the driving motor 460.

The first door part 200 and the second door part 300 for adjusting the introduction of the cabin air and the outside air are adjusted by the rotation of the cam part 400 by receiving driving force from one driving motor 460. The driving motor 460 mentioned above is electrically connected to the controlling unit 500 and is operated according to the control signal of the controlling unit 500 to thereby adjust an angle of the cam part 400, such that the open values of the cabin air inlet 120 and the outside air inlet 140 are adjusted by the first door part 200 and the second door part 300.

Specifically, the cam part 400 is provided with the first slot 420 to which the first door part 200 is connected and the second slot 440 to which the second door part 300 is connected, wherein the first slot 420 is formed to be linearly extended and have both ends which are bent toward the center, and the second slot 440 is formed to be bent at the predetermined curvature. In addition, the first slot 420 and the second slot 440 are formed to be vertical or substantially perpendicular to each other, such that the respective doors 200 and 300 may be rotated by one cam part 400. Here, the first slot and the second slot may be formed to have a predetermined angle according to the shape of the cam part and installation positions of the first door part and the second door part.

The first door part 200 according to the present invention is configured so that the introduction of the cabin air or the introduction of the outside air is switched to thereby be completely moved to the cabin air inlet 120 side or the outside air inlet 140 side. To this end, the first slot 420 of the cam part 400 to which the first door part 200 is connected is configured so that it is rotated to the cabin air inlet 120 side or the outside air inlet 140 side at the bent portion 422 of the end, and the first door part 200 is not rotated at the linearly extended portion 424 even though the cam part 400 is rotated.

Meanwhile, the second door part 300 is configured so as to adjust an introduction amount of outside air by being provided to the outside air inlet 140 side. To this end, the second slot 440 of the cam part 400 to which the second door part 300 is connected is formed to have the predetermined curvature, such that when the cam part 400 is rotated, the second door part 300 is rotated according to the second slot 440. As such, since the second door part 300 is immediately rotated according to the second slot 440 formed so as to have the predetermined curvature, the first door part 200 and the second door part 300 are adjusted according to the rotation of the cam part 400 by the control of the driving motor 460, such that the open value of the outside air inlet 140 may be adjusted.

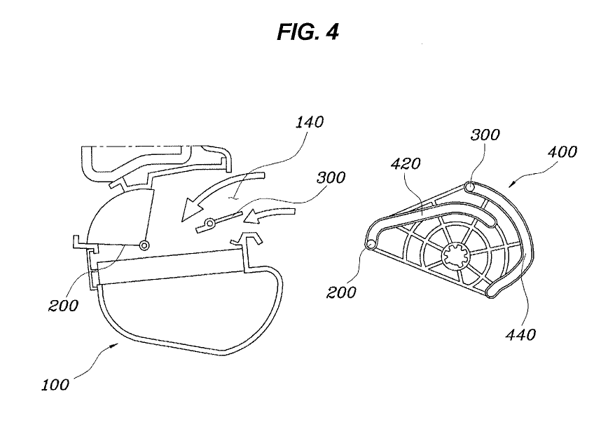

Operation states by the structure described above will be described with reference to the drawings. As shown in FIG. 4, in the case in which only the outside air is intended to be introduced from an air-conditioner, it may be appreciated that as the cam part 400 is rotated to a right side, the first door part 200 and the second door part 300 are moved to one side of each slot, such that the first door part 200 closes the cabin air inlet 120 and the second door part 300 is completely opened.

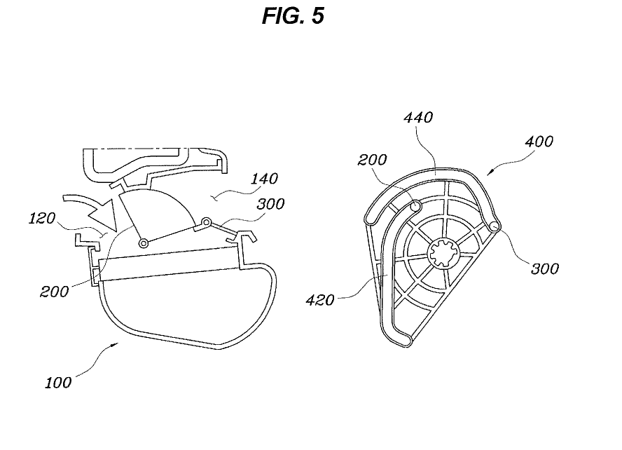

In the case in which only the cabin air is intended to be introduced, as shown in FIG. 5, the cam part 400 is rotated to a left side and the first door part 200 and the second door part 300 are moved to other sides of the respective slots 420 and 440, such that the first door part 200 closes a portion of the outside air inlet 140 and the second door part 300 also closes other portions of the outside air inlet.

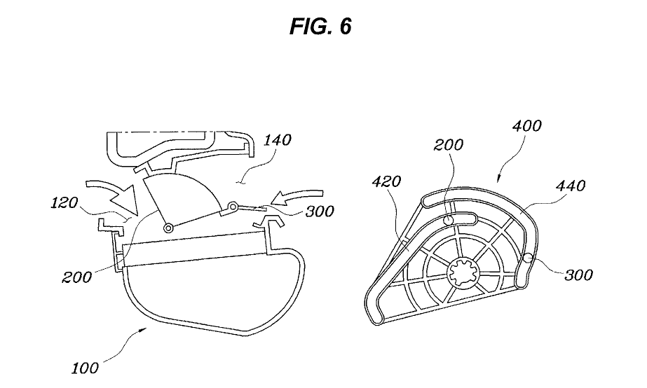

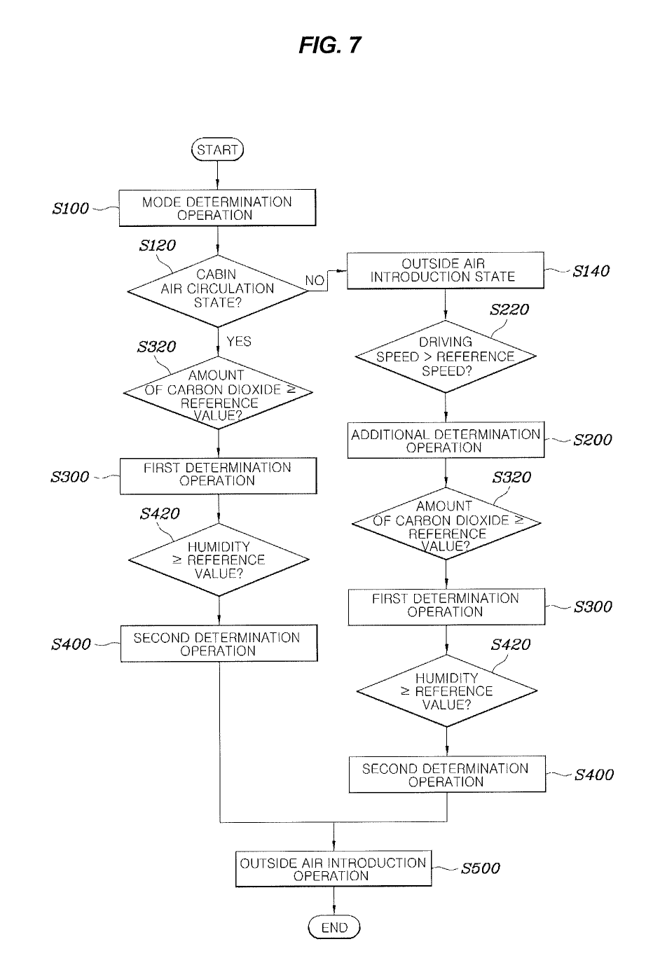

In the case in which the introduction of the outside air is required due to humidity and an amount of carbon dioxide in an interior in this state, as shown in FIG. 6, as the cam part 400 is tilted toward the left side, the second door part 300 is opened to allow the outside air to be introduced and the first door part 200 is not rotated to the cabin air inlet 120 side because it is caught at the linearly formed portion 424 of the first slot 420. As such, in the state in which only the cabin air is intended to be introduced by adjusting only a rotation angle of the second door part 300 while limiting the rotation of the first door part 200, the outside air is partially introduced, such that pleasant air may be maintained in the interior.

Meanwhile, a CO₂ sensing unit (a) detecting an amount of carbon dioxide in the vehicle interior and a humidity sensing unit (b) detecting humidity in the vehicle interior are provided, and the controlling unit 500 has a reference value according to the amount of carbon dioxide and the humidity, and may adjust an introduction amount of outside air by adjusting the cam part 400 in the case in which the amount of carbon dioxide and the humidity in the interior transmitted by the CO₂ sensing unit (a) and the humidity sensing unit (b) are the reference value or more.

The control described above is performed in a cabin air mode state in which the first door part 200 blocks a portion of the outside air inlet and the second door part 300 also blocks the remaining portions of the outside air inlet. The reason is that carbon dioxide in the interior is not accumulated and is discharged to an exterior, and humidity is not generated by allowing air to be circulated into the interior and exterior of the vehicle in a state in which the outside air is sufficiently introduced.

As such, in the cabin air mode state, in the case in which the amount of carbon dioxide or an amount of humidity is excessive as a result of detecting the amount of carbon dioxide in the interior of vehicle and the humidity in the interior thereof by the CO₂ sensing unit (a) and the humidity sensing unit (b), in order to prevent comfortability in the vehicle interior from being degraded, the second door part 300 is adjusted by the adjustment of the cam part 400 to thereby introduce the outside air. That is, in a state in which only the cabin air is circulated, although the first door part 200 and the second door part 300 close the outside air inlet 140, the outside air is introduced through the outside air inlet 140 by rotating the cam part 400 according to the degree of carbon dioxide and humidity in the interior to thereby tilt the second door part 300. Thereby, it is possible to prevent the comfortability from being degraded by carbon dioxide in the interior and to prevent stability from being degraded because visibility is not secured due to humidity.

On the other hand, the controlling unit 500 may have a database in which a generation amount of carbon dioxide in the interior over the time in a cabin air mode state is pre-checked, and may adjust the second door part 300 when arriving at a predetermined time based on the database.

This operation, which may not be used in a case in which the CO₂ sensing unit is not present in the vehicle interior, pre-evaluates the amount of carbon dioxide generated from the interior and adjusts the open value of the outside air inlet based on the evaluation to thereby introduce the outside air.

In the case in which both the first door part 200 and the second door part 300 close the outside air inlet 140 in the vehicle which does not have a separate sensor for detecting carbon dioxide to thereby allow only the cabin air to be circulated, the amount of carbon dioxide in the interior may not be determined, such that there is a limitation in maintaining comfort of the interior air.

In order to solve this problem, in the state in which only the cabin air is circulated, the amount of carbon dioxide discharged from passengers over a predetermined time is evaluated, built in the database, and stored. Here, the generation amount of carbon dioxide over the time in the cabin air circulation state may appropriately set according to the vehicle taking account of a vehicle design, the number of passengers, and the like.

Therefore, even though the CO₂ sensing unit is not provided, in the case in which only the cabin air is circulated, the second door part 300 may be adjusted to thereby introduce the outside air into the interior by determining the amount of carbon dioxide in process of a predetermined time based on the pre-checked database.

Meanwhile, a method of controlling the system for mixing cabin air and outside air of the air-conditioner for the vehicle described above will be described. Here, an air circulation state is classified into a cabin air circulation state and an outside air introduction state. The cabin air circulation state refers to as a state in which the first door part and the second door part close the outside air inlet to thereby allow only the cabin air to be purely circulated, and the outside air introduction state refers to as a state in which the second door part is rotated in the cabin air circulation state to thereby allow the outside air to be introduced. That is, the outside introduction state means that any outside air is introduced through the second door part or through the outside air inlet by adjusting the second door part even in the state in which the first door part and the second door part close the outside air inlet to thereby allow only the cabin air to be circulated.

A method of controlling a system for mixing cabin air and outside air of the air-conditioner for the vehicle may include a mode determination operation (S100) of determining a cabin air circulation state or an outside air introduction state; a first determination operation (S300) of checking an amount of carbon dioxide in an interior (S320) and determining an introduction amount of outside air for the amount of carbon dioxide in a case of the cabin air circulation state (S120); a second determination operation (S400) of checking whether or not humidity in the interior is a reference value or more (S420) and calculating an introduction amount of outside air for the humidity in the case in which the humidity is the reference value or more; and an outside air introduction operation (S500) of adjusting an open value of an outside air inlet so that the outside air is introduced based on the introduction amount of outside air derived from the first determination operation (S300) or the second determination operation (S400).

Here, in a case of the cabin circulation state, in the outside air introduction operation (S500), the first door part closes the outside air inlet or a portion of the outside air inlet and only the second door part is operated, thereby adjusting the introduction amount of outside air. In the present invention, the cabin circulation state refers to as a state in which the first door part and the second door part close the outside air inlet. In this state, the open value of the outside air inlet is adjusted by only the second door part to thereby adjust the introduction amount of outside air, such that the outside air is introduced a little or in a relatively smaller amount or gradually, if necessary, while maintaining the cabin circulation state, thereby making it possible to pleasantly maintain the interior.

In the first determination operation (S300) and the second determination operation (S400) according to various embodiments of present invention, a database for carbon dioxide and humidity is provided. Here, in the first determination operation (S300), in the case in which a CO₂ sensing unit is provided in the vehicle, it may be checked whether or not the amount of carbon dioxide in the interior measured by the CO₂ sensing unit is the reference value or more, and in the case in which the amount of carbon dioxide is the reference value or more, a second door part may be adjusted to thereby adjust the introduction amount of outside air.

For example, in the cabin circulation state, in the case in which the amount of carbon dioxide detected by the CO₂ sensing unit is 500 ppm or less, the first door part and the second door part close the outside air inlet to thereby allow the open value of the outside air inlet to be 0%. If the amount of carbon dioxide is more than 500 ppm, the second door part is adjusted to thereby allow the open value of the outside air inlet to be about 20%, and if the amount of carbon dioxide becomes 1000 ppm or more, the second door part is adjusted to thereby allow the open value of the outside air inlet to be about 30%, such that the second door part is adjusted depending on an increased amount of carbon dioxide, thereby making it possible to gradually increase the open value of the outside air inlet. As such, it is possible to manage the amount of carbon dioxide while maintaining the cabin circulation state by performing a multi-step control according to the increase of the amount of carbon dioxide using the second door part.

On the other hand, in the first determination operation (S300), the second door part is adjusted when arriving at a predetermined time based on the database in which a generation amount of carbon dioxide in the interior over the time is pre-checked, thereby making it possible to adjust the introduction amount of outside air.

In the case in which the vehicle does not have the CO₂ sensing unit in the interior thereof, it is possible to provide against carbon dioxide accumulated in the interior in the cabin circulation state using the database in which the generation amount of carbon dioxide over the time is pre-evaluated as described above.

As such, in the state in which only the cabin air is circulated, the second door part may be adjusted to thereby introduce the outside air into the interior by determining the amount of carbon dioxide in process of a predetermined time based on the pre-checked database, thereby making it possible to maintain pleasant air.

Meanwhile, in the case in which the humidity detected from the second determination operation (S400) is the reference value or less, the open value of the outside air inlet is controlled to be 0%, such that only the cabin air is circulated. In the case in which the humidity is the reference value or more, the open value of the outside air inlet may be set to be increased.

For example, in the cabin circulation state, in the case in which the humidity in the interior is the reference value or less, the first door part and the second door part close the outside air inlet to thereby allow the open value of the outside air inlet to be 0%. In the case in which the humidity detected in this state exceeds the reference value, the second door part is adjusted to thereby allow the outside air to be introduced. Here, the open value of the outside air inlet may be increased by adjusting the second door part in proportion to the humidity detected from the interior.

However, in the case in which the humidity in the interior is high and therefore the interior of vehicle becomes damp, visibility is not secured to thereby make driving safety dangerous. Therefore, when the humidity in the interior becomes high, it is preferable to increase the introduction amount of outside air by rotating both the first door part and the second door part to the cabin air inlet.

Here, in the outside air introduction operation (S500), in the case in which both carbon dioxide and humidity in the interior are the reference value or more, the introduction amount of outside air according to humidity information among the introduction amounts of outside air calculated by the first determination operation (S300) and the second determination operation (S400) may be firstly controlled.

When the humidity in the vehicle interior becomes high, visibility of a driver is not secured due to a damp glass of the interior, such that driving safety may be degraded. That is, since it is more important to secure safety due to the humidity than comfort according to the amount of carbon dioxide, in the case in which the introduction amount of outside air derived from the second determination operation (S400) among the introduction amounts of outside air calculated by the first determination operation (S300) and the second determination operation (S400) is large, the open value of the outside air inlet is adjusted based on this introduction amount of outside air to thereby allow the outside air to be introduced. Thereby, driving safety may be secured and reliability for the vehicle may be provided to the driver.

Meanwhile, in the outside air introduction operation (S500), in the case in which both carbon dioxide and humidity in the interior are the reference value or more, the open value of the outside air inlet may be adjusted based on the introduction amount of outside air having a large value among the introduction amounts of outside air calculated by the first determination operation (S300) and the second determination operation (S400).

As such, the open value of the outside air inlet is adjusted based on the introduction amount of outside air having a large value among the introduction amounts of outside air calculated by the first determination operation and the second determination operation, thereby making it possible to simultaneously secure comfort and safety according to carbon dioxide or humidity. That is, since each of the first determination operation and the second determination operation has calculating data and the calculated introduction amounts of outside air are different from each other, the open value of the outside air inlet is adjusted based on the calculated introduction amount of outside air having the large value.

However, in the case in which the humidity in the interior is more than the reference value, it is preferable to consider safety as an important thing by adjusting the open value of the outside air inlet based on the introduction amount of outside air calculated by the second determination operation.

Meanwhile, the mode determination operation (S100) may further include additional or optional operations such as an additional determination operation (S200) of checking a driving speed of the vehicle (S220) in a case of the outside air introduction state (S140) and calculating the introduction amount of outside air for the driving speed in the case in which the driving speed of the vehicle is a reference speed or more.

In the outside air introduction state in which the outside air is partially introduced through the second door part, in the state in which the cabin air is calculated, when the vehicle is driven at a driving speed which is the reference speed or more, the outside air introduced from the outside air inlet may flow backward to the cabin air inlet side due to a pressure difference between the outside air inlet side and the cabin air inlet side.

In order to prevent this problem, the introduction amount of outside air is calculated by checking the driving speed of the vehicle and substituting data according to the driving speed. As such, the open value of the outside air inlet is adjusted so that the introduction amount of outside air is decreased according to the speed of the vehicle based on the calculated introduction amount of outside air, thereby making it possible to solve the problem in that the outside air flows backward to the cabin air inlet side.

In the outside air introduction operation, the open value of the outside air inlet is adjusted so that the outside air is introduced based on the introduction amounts of outside air calculated by the additional determination operation, the first determination operation, and the second determination operation, and the introduction amount of outside air calculated by the second determination operation is firstly controlled, such that it is preferable to prevent a safety accident from being generated due to visibility degraded by the humidity.

Meanwhile, in the additional determination operation (S200), as the driving speed of the vehicle is high (i.e., above a predetermined speed), a shift level of a blower may be increased. As such, the shift level of the blower is adjusted according to the driving speed of the vehicle to thereby allow the outside air introduced from the outside air inlet to be moved to the blower side, making it possible to prevent the back flow of the outside air to the cabin air inlet.

According to various embodiments of the present invention, in the system for mixing the cabin air and the outside air of the air-conditioner for the vehicle having the structure as described above, the first door part and the second door part are configured and the rotation angles of the first door part and the second door part may be adjusted by the rotation of the cam part, thereby making it possible to solve the increase in costs caused by the additional installation of the motor.

In addition, the introduced amount of outside air may be adjusted by variably controlling the second door part and may be adjusted by checking carbon dioxide and humidity in the vehicle interior, thereby making it possible to prevent carbon dioxide and humidity from being generated in the interior while minimizing the ventilation loss.

For convenience in explanation and accurate definition in the appended claims, the terms “left” or “right”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for mixing cabin air and outside air of an air-conditioner for a vehicle, the system comprising:
a housing of the air-conditioner having a cabin air inlet for ventilating the cabin air and an outside air inlet for ventilating the outside air;
a first door part provided to selectively cover at least a portion of the cabin air inlet and/or a portion of the outside air inlet to thereby adjust an open value of each of the inlets;
a second door part provided to selectively cover the remaining portion of the outside air inlet to thereby adjust the open value of the outside air inlet;
a cam part rotatably installed in the housing and formed with first and second slots, wherein the first door part is slidably coupled to the first slot and the second door part is slidably coupled to the second slot such that a rotation angle of the first door part or the second door part is varied according to a rotation of the cam part; and
a controlling unit controlling the rotation of the cam part.

2. The system according to claim 1, wherein the first door part is formed in a substantially dome form having a fan shape, and the second door part is formed in a substantially flat form having a plate shape.

3. The system according to claim 1, wherein the first slot of the cam part is formed to be linearly extended and have both ends which are bent toward a center of the cam part, and the second slot of the cam part is formed to be bent at a predetermined curvature.

4. The system according to claim 1, wherein the first slot and the second slot of the cam part are formed to be substantially perpendicular to each other.

5. The system according to claim 1, wherein the cam part is rotated by a driving motor provided therein, and the controlling unit adjusts the rotation of the driving motor by transmitting a control signal to the driving motor.

6. The system according to claim 1, further comprising:
a CO₂ sensing unit detecting an amount of carbon dioxide in a vehicle interior; and
a humidity sensing unit detecting humidity in the vehicle interior;
wherein the controlling unit adjusts an introduction amount of the outside air by adjusting the cam part when the amount of the carbon dioxide in the interior transmitted by the CO₂ sensing unit is equal to or greater than a reference value and/or the humidity in the interior transmitted by the humidity sensing unit is equal to or greater than a reference value.

7. The system according to claim 1, wherein the controlling unit has a database in which a generation amount of carbon dioxide in a vehicle interior over time in a cabin air mode state is pre-checked, and adjusts the second door part when arriving at a predetermined time based on the database.

8. A method of controlling the system for mixing cabin air and outside air of the air-conditioner for a vehicle according to claim 1, the method comprising:
a mode determination operation of determining a cabin air circulation state or an outside air introduction state;
a first determination operation of checking an amount of carbon dioxide in an interior and determining an introduction amount of the outside air based on the amount of the carbon dioxide in a case of the cabin air circulation state;
a second determination operation of checking whether or not humidity in the interior is equal to or greater than a reference value and determining an introduction amount of the outside air based on the humidity when the humidity is equal to or greater than the reference value; and
an outside air introduction operation of adjusting the open value of the outside air inlet so that the outside air is introduced based on the introduction amounts of the outside air derived from the first determination operation and/or the second determination operation.

9. The method according to claim 8, wherein in the case of the cabin circulation state, in the outside air introduction operation, the first door part closes a portion of the outside air inlet and only a second door part is operated, thereby adjusting the introduction amount of the outside air.

10. The method according to claim 8, wherein in the first determination operation, in a case in which a CO₂ sensing unit is provided in the vehicle, it is checked whether or not the amount of the carbon dioxide in the interior measured by the CO₂ sensing unit is equal to or greater than the reference value, and in the case in which the amount of carbon dioxide is equal to or greater than the reference value, the second door part is adjusted to thereby adjust the introduction amount of the outside air.

11. The method according to claim 8, wherein in the first determination operation, the second door part is adjusted when arriving at a predetermined time based on a database in which a generation amount of the carbon dioxide in the interior over time is pre-checked, such that the introduction amount of outside air is adjusted.

12. The method according to claim 8, wherein in the outside air introduction operation, between the introduction amounts of outside air derived by the first determination operation and the second determination operation, the introduction amount of the outside air according to the humidity in the second determination operation is firstly controlled.

13. The method according to claim 8, wherein in the outside air introduction operation, the open value of the outside air inlet is adjusted based on the introduction amount of the outside air derived by the first determination operation or the introduction amount of the outside air derived by the second determination operation, whichever is larger.

14. The method according to claim 8, wherein the mode determination operation further includes an additional determination operation of checking a driving speed of the vehicle in a case of the outside air introduction state and determining the introduction amount of the outside air for the driving speed when the driving speed of the vehicle is equal to or greater than a reference speed.

15. The method according to claim 14, wherein in the outside air introduction operation, the open value of the outside air inlet is adjusted so that the outside air is introduced based on the introduction amounts of the outside air derived by the additional determination operation, the first determination operation, and/or the second determination operation, the introduction amount of the outside air calculated by the second determination operation being firstly controlled.

16. The method according to claim 14, wherein in the additional determination operation, as the driving speed of the vehicle is high, a shift level of a blower is increased.
